(19) United States
(12) Patent Application Publication
(10) Pub. No.: US 2013/0259042 A1
(43) Pub. Date: Oct. 3, 2013

(54) MULTICAST PACKET TRANSMISSION

(71) Applicant: Hangzhou H3C Technologies Co., Ltd., Hangzhou (CN)

(72) Inventors: Xiaoheng Song, Beijing (CN); Chaoqun Wang, Beijing (CN)

(73) Assignee: Hangzhou H3C Technologies Co., Ltd., Hangzhou (CN)

(21) Appl. No.: 13/905,127

(22) PCT Filed: Feb. 22, 2012
(86) PCT No.: PCT/CN2012/071427

§ 371 Date: May 30, 2013

(30) Foreign Application Priority Data
Feb. 22, 2011 (CN) 201110042521.X

(51) Int. Cl. H04L 12/18

(52) U.S. Cl. CPC H04L 12/18
USPC 370/390

(57) ABSTRACT

A method for multicast packet transmission by a first provider edge device in a virtual switching instance, in which the first provider edge device transmits, to a second provider edge device in the virtual switching instance, a packet having an address of a private network multicast group and an address of a public network multicast group associated with the private network multicast group. The first provider edge device receives, from the second provider edge device, a join request packet to join the public network multicast group. The first provider edge device stores forwarding information for the public network multicast group, wherein the forwarding information relates to an interface over which the join request packet is received by the first provider edge device. The first provider edge device encapsulates a multicast packet for the private network multicast group with the address of the public network multicast group. The first provider edge device transmits the encapsulated multicast packet according to the address of the public network multicast group and forwarding information.

### BACKGROUND

Virtual private local area network service (VPLS) is a transparent LAN service that interconnects geographically dispersed LAN segments across a multiprotocol label switching (MPLS) network. The LAN segments are interconnected via a public network backbone, such as a metropolitan area network (MAN) or wide area network (WAN). The LAN segments in a VPLS appear to be on the same LAN regardless of their locations, and can function as a single virtual LAN.

Multicast refers to a point-to-multipoint communication where information is delivered to a group of destination devices, and is useful in many applications, such as Internet Protocol Television (IPTV), video conferencing, video on demand, e-learning and web casts. In a VPLS network, when a multicast source provider edge (PE) device transmits multicast packets to peer PE devices, the packets are replicated at the multicast source and transmitted to each peer PE device via a public network in a broadcast or unicast manner.

### BRIEF DESCRIPTION OF DRAWINGS

By way of non-limiting examples, multicast packet transmission will be described with reference to the following drawings, in which:

FIG. 1 is a schematic diagram of an example of a VPLS network in which multicast packets are transmitted;

FIG. 2 is a flowchart of an example method of a provider edge (PE) device joining a private network multicast group in a VPLS network;

FIG. 3 is a schematic diagram illustrating an example method of a PE device joining a private network multicast group in the VPLS network in FIG. 1;

FIG. 4(a) is a diagram of an example packet structure of an extended IGMP packet for joining or leaving a private network multicast group;

FIG. 4(b) is a diagram of an example packet structure of an encapsulated Internet Group Management Protocol (IGMP) packet;

FIG. 4(c) is a diagram of an example packet structure of an encapsulated multicast domain (MD) packet;

FIG. 5 is a flowchart of an example method of a multicast source triggering PE devices to join a public network multicast group in a VPLS network;

FIG. 6 is a schematic diagram illustrating an example method of a multicast source triggering PE devices to join a public network multicast group in the VPLS network in FIG. 1;

FIG. 7 is a flowchart of an example method of forwarding multicast packets;

FIG. 8 is a schematic diagram of an example VPLS network having a different topology to that of the VPLS network in FIG. 1;

FIG. 9 is a flowchart of an example method of a provider edge (PE) device leaving a private network multicast group in a VPLS network;

FIG. 10 is a schematic diagram illustrating an example method of a PE device leaving a private network multicast group in the VPLS network in FIG. 1;

FIG. 11 is a schematic diagram illustrating an example method of a PE device leaving a public network multicast group in the VPLS network in FIG. 1; and

FIG. 12 is a block diagram of an example structure of a network device.

### DETAILED DESCRIPTION

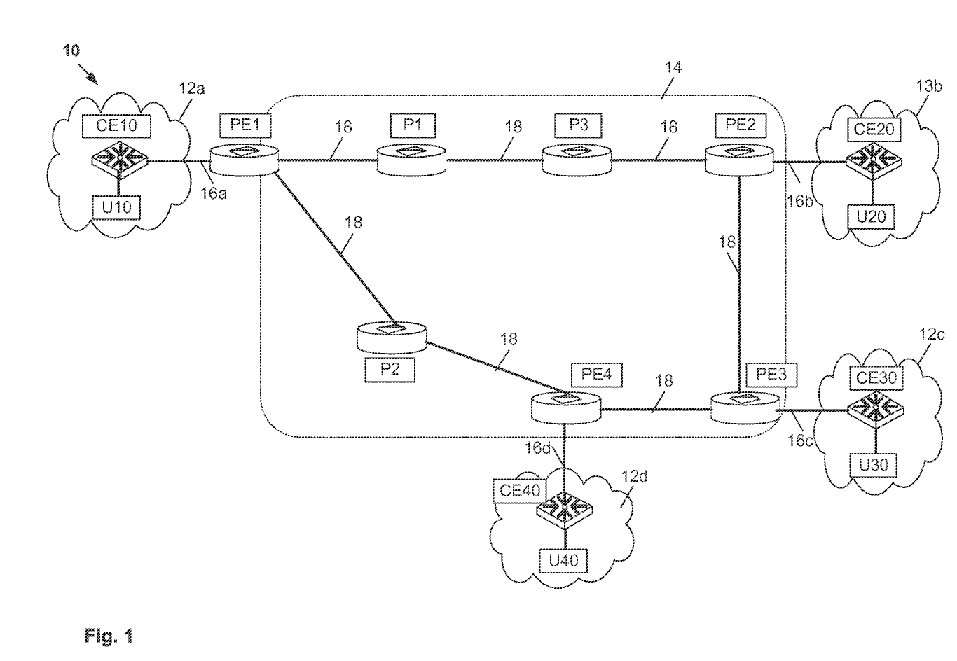

Referring first to FIG. 1, an example VPLS network 10 is shown where geographically dispersed customer sites 12a, 12b, 12c and 12d are connected over a service provider network 14. The service provider network 14 may be a packet-switched network using multiprotocol label switching protocol (MPLS) etc.

The example VPLS network 10 comprises network devices capable of acting as provider edge (PE) devices, intermediate provider (P) devices and customer edge (CE) devices. In this example, PE devices PE1, PE2, PE3 and PE4 at the edge of the service provider network 14 have functionality to interface with respective CE devices CE10, CE20, CE30 and CE40. P devices P1, P2 and P3 forward traffic between PE devices. The PE and P devices may be routers, bridges, switches, or hosts etc.

The PE devices are each connected to the respective CE device via an attachment circuit (AC) 16a, 16b, 16c and 16d. An AC may be a logical or physical circuit, such as an RS-232 serial line or an ATM virtual circuit etc. The CE devices may be routers, bridges, switches, or hosts etc.

A set of virtual circuits (VCs) 18, termed pseudo wires (PWs), are established between the PE devices to provide forwarding paths. Construction of a PW involves the configuration of a pair of uni-directional label switched paths (LSPs) between the PE devices. Once this LSP tunnel is established, a PW is assigned to a pair of LSPs and the tunnel provides connectivity to transport packets across the network from one PE to another.

At the customer sites 12a, 12b, 12c and 12d, network devices U10, U20, U30, and U40 are connected to respective CE devices CE10, CE20, CE30 and CE40. The network devices U10, U20, U30 and U40 may each be a desktop computer, laptop computer, mobile communications equipment, tablet computer, digital television, set-top box, router, bridge, switch, or host etc.

All CE devices participating in a single VPLS instance appear to be on the same LAN, forming a virtual private network (VPN) across the service provider's network. To implement a VPLS instance, a virtual switching instance (VSI) is created on the PE devices. The VSI is a logical entity in a PE device that operates as a switch between one or more ACs and PWs. Each VSI is associated with an identification number, VSI-ID. For example, PE devices PE1, PE2, PE3 and PE4 in FIG. 1 are associated with a single VSI having VSI-ID=VSI1.

In the examples below, PE2 serves as a multicast source (also referred to as “first PE device”), and PE1, PE3 and PE4 are peer PE devices (also referred to as “second PE devices”). In particular, in the examples, a second PE device (PE1, PE4) joins a private network multicast group. To facilitate multicast packet transmission, the first PE device (PE2) transmits, to the second PE device (PE1, PE4), a packet having an address of a private network multicast group and an address of a public network multicast group associated with the private network multicast group. In response, the second PE device (PE1, PE4) transmits a join request packet to the first PE device (PE2) to join the public network multicast group. The first PE device (PE2) stores forwarding information relating an interface over which the join request packet is received. The first PE device (PE2) then encapsulates a multicast packet for the private network multicast group with the address of the public network multicast group, and sends the multicast packet according to the address of the public network multicast group and forwarding information. A second PE device (PE1, PE4) may leave the private network multicast group and public network multicast group at any time. Examples of these processes are described in more detail below.

Private Network Multicast Group

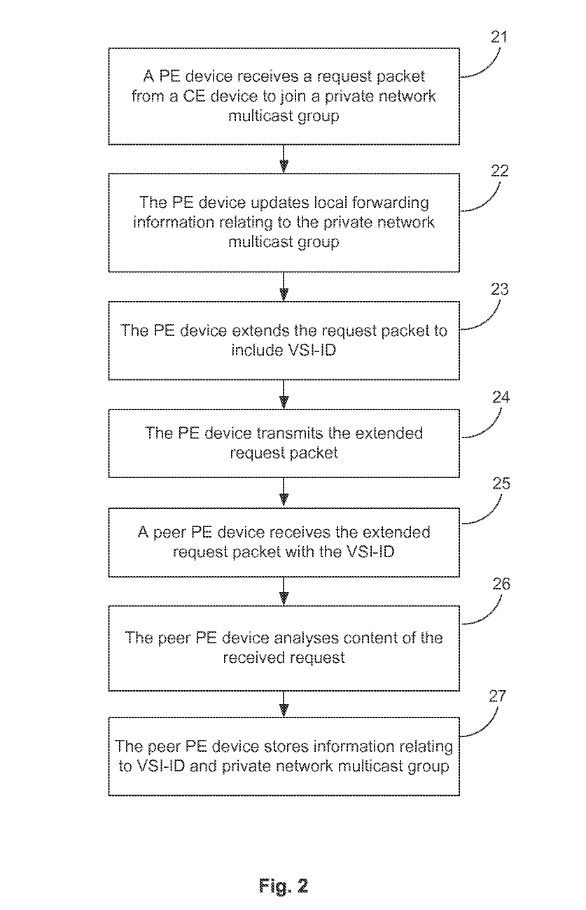

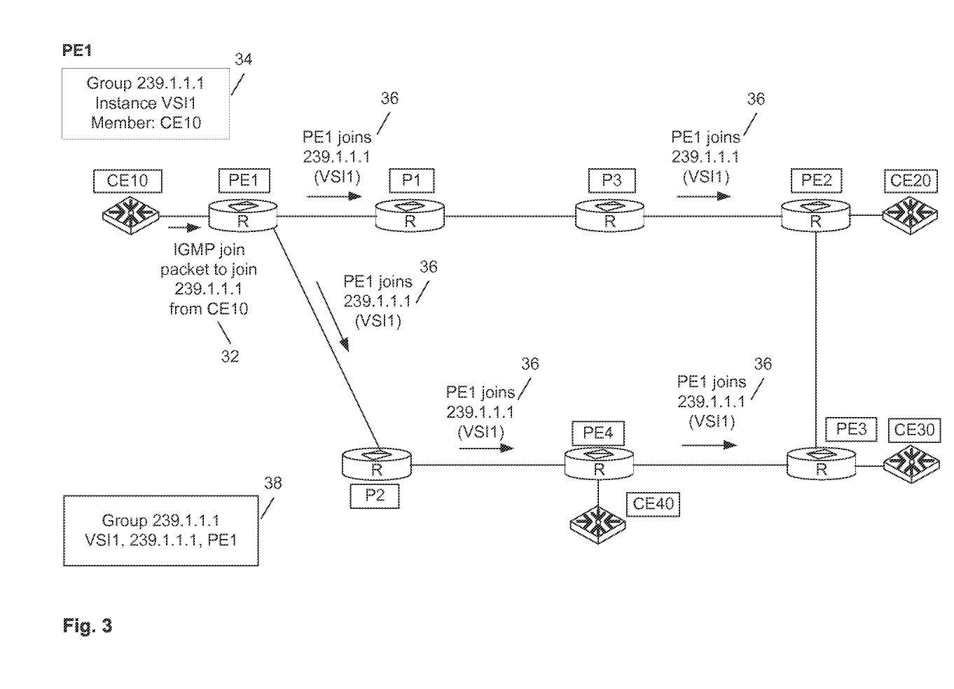

An example method of joining a private network multicast group in the VPLS network 10 will be explained with reference to FIG. 2 and FIG. 3. Any suitable communications protocol for managing group membership may be used, such as the Internet Group Management Protocol (IGMP) exemplified below.

A PE device receives a request packet from a connecting CE device to join a private network multicast group; see block 21. If IGMP is enabled on the AC between the PE device and CE device, the request packet may be in the form of an IGMP request packet etc. In the example in FIG. 3, PE1 receives an IGMP request packet from CE10 to join private network multicast group 239.1.1.1; see 32.

In this case, it should be understood that either the CE device, or a user device connected to the CE device (such as U10, U20, U30 and U40 in FIG. 1), wishes to receive multicast packets for the private network multicast group. Throughout this disclosure, a CE device is referred to as a “receiver” of the private network multicast group if the end destination of the multicast packets is either (i) the CE device itself or (ii) a device connected to the CE device. In the latter case (ii), the CE device is also a “receiver” of the first private network multicast group because it receives and forwards the multicast packets to the connecting device. Also, from the perspective of the PE device, the CE device is a receiver of the private network multicast group because the multicast packets should be forwarded to the CE device.

The PE device updates local forwarding information relating to the private network multicast group; see block 22 in FIG. 2. Specifically, the PE device determines whether the private network multicast group already exists in the VSI. If not, the PE device updates local forwarding information relating to the private network multicast group. The local forwarding information may be in the form of an entry in a forwarding table, which stores the CE device as receiver of the private network multicast group.

Otherwise, if a forwarding table entry for the private network multicast group already exists, the PE device adds an entry to the forwarding table stating the CE device is a receiver of the private network multicast group. In the example in FIG. 3, PE1 creates an entry in a local forwarding table for 239.1.1.1 in VSI1, with CE10 as an outgoing interface of 239.1.1.1; see 34.

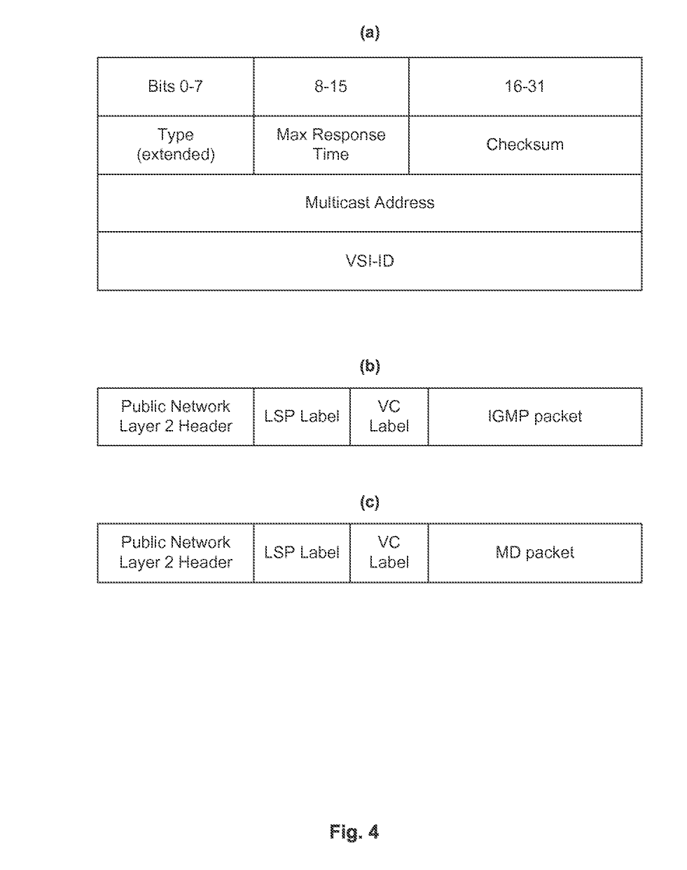

The PE device then extends the IGMP request packet to include an identifier VSI-ID of the VSI; see block 23 in FIG. 2. An example structure of an extended IGMPv2 request packet is shown in FIG. 4(a), where:
‘Type’ identifies the IGMP packet type, such as 0x11 for a query packet; 0x16 for a report packet; and 0x26 for an extended request packet;
‘Max Response Time’ identifies a maximum time to wait before responding to a query packet;
‘VSI-ID’ is the ID of the VSI, identifying the instance number to which the IGMP request packet belongs;
‘Checksum’ is a check sum for the IGMP packet; and
‘Multicast Address’ is an address of the private network multicast group, such as 239.1.1.1 used in this example.

The packet extension allows receiving PE devices to distinguish the IGMP request packets from data packets and process the IGMP request packets differently. After the extension, the PE device transmits the extended request packet to peer PE devices in the VSI; see block 24 in FIG. 2.

The transmission of the extended request packet is performed in a broadcast manner. FIG. 3 illustrates an IGMP request packet flooding process, where PE1 transmits the extended IGMP request packet 36 to peer PE devices PE2, PE3 and PE4. An example structure of the extended IGMP packet broadcasted by PE1 is shown in FIG. 4(b) where the packet is encapsulated with a public network Layer 2 header, a VPLS label tunnel header, and a VC label.

Once the extended IGMP request packet 36 is received, the packet is analysed by the peer PE devices PE2, PE3 and PE4 within VSI1; see blocks 25 and 26 in FIG. 2. From the analysis, the PE devices then store the information relating to the VSI-ID, private network multicast group and PW information contained in the packet at block 27.

The PW information relates to the connection between the sender of the request packet (PE1) and receiving PE devices (PE2, PE3 or PE4). In VPLS, the PW information may be the IP address of the sender of the request packet etc. In the example in FIG. 3, each PE device within VSI1 stores the following membership information 38:
VSI-ID: VSI1;
Private network multicast group address: 239.1.1.1; and
PW information: IP address of PE1.

In the example in FIG. 3, the membership information 38 is useful for peer PE devices PE2, PE3 and PE4 to learn that a CE device connected to PE1 is a receiver of private network multicast group 239.1.1.1. For a multicast source, say PE2, the information is useful when determining whether private network multicast group 239.1.1.1 has any member. If not, it is not necessary to transmit any multicast packet to this group.

Similarly, when PE4 receives an IGMP request packet from CE40 to join private network multicast group 239.1.1.1, PE4 will perform blocks 21 to 24 in FIG. 2 to add CE40 as an outgoing interface for 239.1.1.1, extend the IGMP request packet to carry the VSI-ID and transmit the extended packet within the VSI1 domain.

Peer PE devices PE1, PE2 and PE3 will process the extended IGMP request packet according to blocks 25 to 27 in FIG. 2, after which the following membership information is stored:
VSI-ID: VSI1;
Private network multicast group address: 239.1.1.1; and
PW information: IP address of PE4.

Public Network Multicast Group

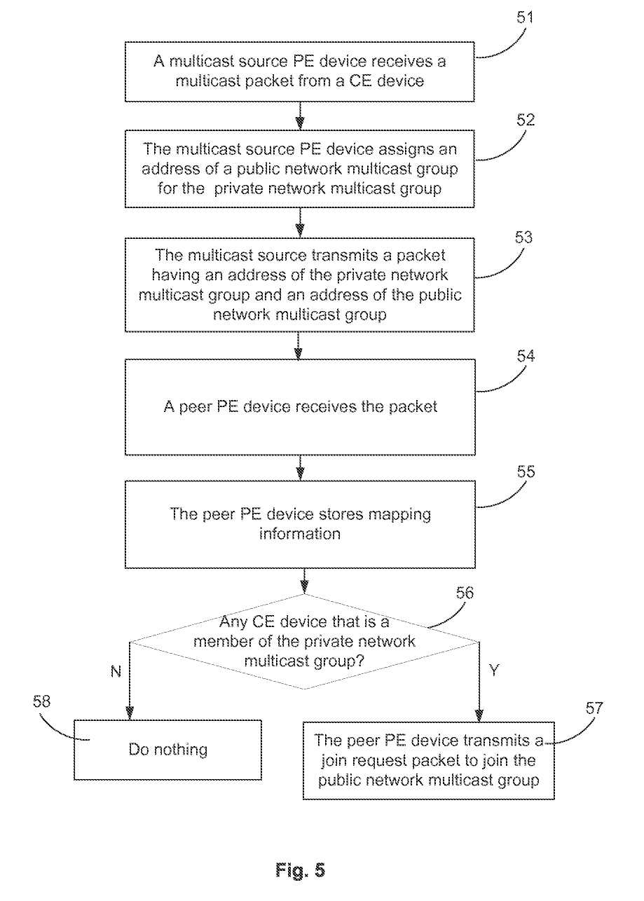

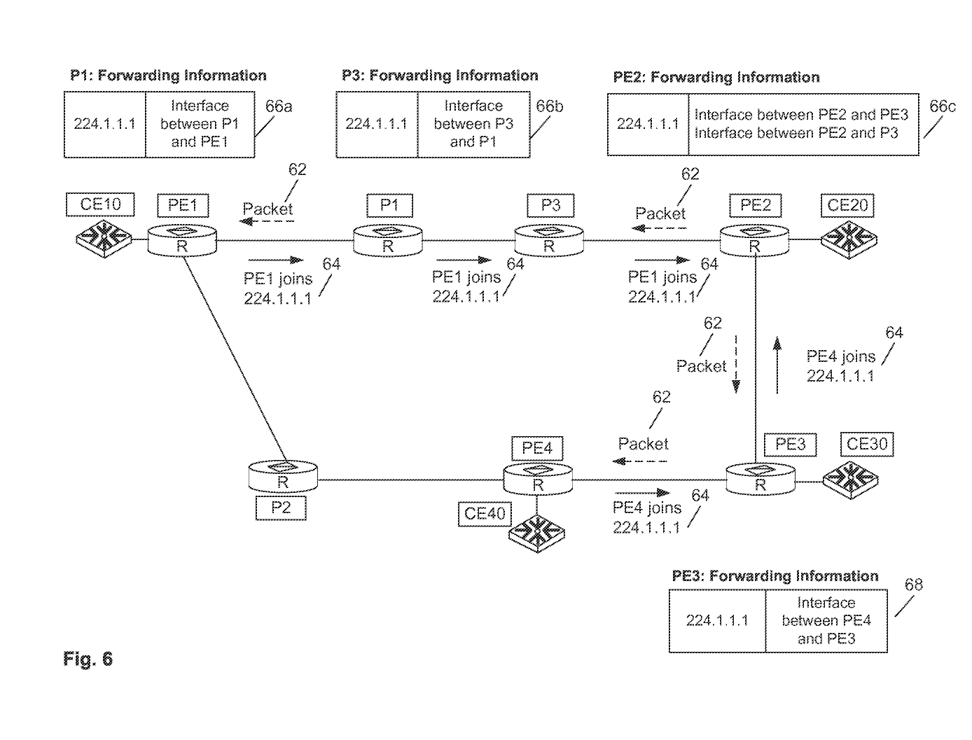

To facilitate transmission of multicast packets by a multicast source over a public network, PE devices join a public network multicast group associated with the private network multicast group. An example method of joining a public network multicast group will be explained with reference to the flowchart in FIG. 5 and schematic diagram in FIG. 6.

At block 51 in FIG. 5, a multicast source PE device receives a multicast packet from a connecting CE device for transmission to a private network multicast group.

At block 52, the multicast source PE device assigns a public network multicast group address for the private network multicast group. The public network multicast group address represents an address of a public network tunnel assigned for the private network multicast group. The multicast source PE device also adds a public network tunnel interface to the private network multicast group.

At block 53, the multicast source PE device transmits a packet having an address of the private network multicast group and an address of the public network multicast group within the VSI domain. The packet may be in the form of a multicast domain (MD) packet etc. Prior to transmitting the MD packet within the VSI domain, the multicast source PE device encapsulates the packet with a VC label, a LSP tunnel label, and a public network layer 2 header. An example of the encapsulated MD packet is shown in FIG. 4(c).

For example, in the schematic diagram in FIG. 6, after receiving a multicast packet transmitted by CE20, multicast source PE2 assigns public network multicast group address 224.1.1.1 for the private network multicast group 239.1.1.1. In one example, the public network multicast group address is assigned once, in which case blocks 52 and 53 are triggered when a first packet of a multicast transmission is received by the multicast source PE device at block 51.

At block 54, a peer PE device receives and analyses the packet transmitted by the multicast source. In the example in FIG. 6, the MD packet 62 carrying addresses 239.1.1.1 and 224.1.1.1 transmitted by PE2 is received by PE devices PE1, PE3 and PE4.

At block 55, based on the address information in the packet, the peer PE device stores mapping information relating to the association between the address of the private network multicast group and the address of the public network multicast group. In the example in FIG. 6, PE1, PE3 and PE4 each stores mapping information between 239.1.1.1 and 224.1.1.1.

At block 56, the peer PE device determines whether any local CE device connected to the peer PE device is a receiver of the private network multicast group; see block 56. The determination is based on the local forwarding information relating to the private network multicast group stored at block 22 in FIG. 2.

If there is a local CE device that is a receiver of the private network multicast group, the peer PE device will transmit a join request packet within the VSI domain to join the public network multicast group; see block 57. The join request packet may be in the form of a protocol independent multicast (PIM) packet etc. Variants such as PIM sparse mode (PIM-SM) and PIM dense mode (PIM-DM) etc may be used.

In the example in FIG. 6, CE10 (connected to PE1) and CE40 (connected to PE4) are both receivers of 239.1.1.1, and should receive any multicast packets addressed to 239.1.1.1. In other words, PE1 and PE4 have the private network multicast group address 239.1.1.1 locally. As such, PE1 and PE4 each transmit a PIM packet 64 to join 224.1.1.1 in the service provider network.

The PIM join packet transmitted by PE1 is forwarded upstream via intermediate P devices P1 and P3 before reaching multicast source PE2. The PIM join packet transmitted by PE4 is forwarded upstream to reach multicast source PE2 via PE3. The upstream route is determined from a unicast routing table of PE1 and PE4, which transmitted the PIM join packet.

In one implementation of block 53, the MD packet is broadcasted within the whole VSI1 domain such that PE3 also stores mapping information between the public network multicast group address 224.1.1.1 and private network multicast group address 239.1.1.1. Advantageously, when PE3 receives an IGMP join packet from CE30 to join 239.1.1.1, PE3 can proceed to transmit a PIM packet to join 224.1.1.1 instead of waiting for an MD packet from PE2.

In another example of block 53, the MD packet is only be transmitted to peer PE devices that are connected to at least one receiver of the private network multicast group. In the example in FIG. 5, since PE2 has information that PE1 and PE4 have joined 239.1.1.1, the MD packet is only sent to PE1 and PE4.

Since PE3 does not have any connecting CE devices that are receivers of private network multicast group 239.1.1.1, PE3 proceeds to do nothing according to block 58 in FIG. 5.

Forwarding Information for the Public Network Multicast Group

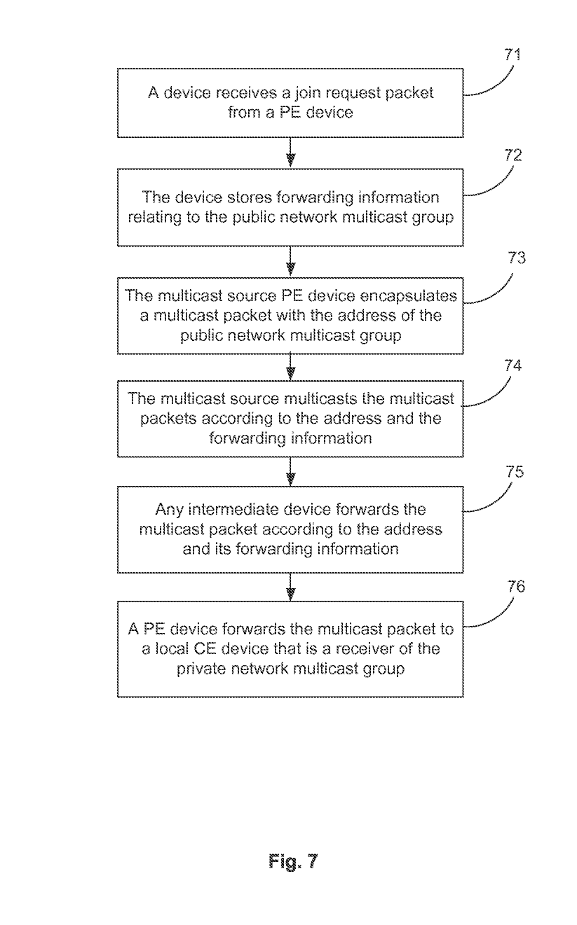

When the join request packet transmitted by a PE device is received, the receiving device stores forwarding information relating to the public network multicast group; see blocks 71 and 72 in FIG. 7.

The forwarding information may be in the form of a forwarding table created for the public network multicast group. An entry in the table includes the address of the public network multicast group and an interface over which the join request packet is received by the device. The interface, which may be a port of the device etc, serves an outgoing interface for the public network multicast group at the device.

Referring to the example in FIG. 6 again, when the PIM join packet from PE1 is received, the following forwarding information is stored for the public network multicast group address 224.1.1.1:
66a at P1: 224.1.1.1→Interface between P1 and PE1;
66b at P3: 224.1.1.1→Interface between P3 and P1; and
66c at PE2: 224.1.1.1→Interface between PE2 and P3.

When the PIM join packet from PE4 is received, the following forwarding information for the public network multicast group address 224.1.1.1 is stored:
68 at PE3: 224.1.1.1→Interface between PE3 and PE4; and
66c at PE2: 224.1.1.1→Interface between PE2 and PE3.

As such, the forwarding table for 224.1.1.1 at multicast source PE2 has two entries:
66c at PE2: 224.1.1.1→Interface between PE2 and P3; and 224.1.1.1→Interface between PE2 and PE3.

Forwarding Multicast Packets

Based on the forwarding information stored for the public network multicast group, multicast packets for the private network multicast group may then be forwarded in a multicast manner

Referring to FIG. 7 again, at block 73, the multicast source PE device encapsulates a multicast packet received from a CE device with the address of the public network multicast group. In one example, the address is in a public network tunnel header of the packet.

At block 74, the PE then multicasts the multicast packet in the VSI according to the address of the public network multicast group in the public network tunnel header and the forwarding information stored at block 72 in FIG. 7.

At block 75, any device that receives the encapsulated multicast packet also forwards the packet according to the address and its own forwarding table for the public network multicast group.

At block 76, if a PE device receiving the encapsulated packet is connected to a local CE device which is a receiver of the private network multicast group, the PE device will forward the multicast packet to the local CE device.

Referring to the example in FIG. 6 again, PE2 forwards multicast packets from CE20 according to the forwarding table for public network multicast group 224.1.1.1, which is associated with the following outgoing interfaces.

(i) The first outgoing interface for 224.1.1.1 in the forwarding table at PE2 is the interface between PE2 and P3, in which case the multicast packet is forwarded by PE2 to P3.

Based on the header of the multicast packet, P3 determines that the multicast packet is for public network multicast group address 224.1.1.1. In its forwarding table for 224.1.1.1, the outgoing interface for 224.1.1.1 is the interface between P3 and P1. As such, P3 forwards the multicast packet to P1.

Upon receiving the multicast packet from P3, P1 analyses the header of the multicast packet. Based on the packet header and its forwarding table for 224.1.1.1, the outgoing interface for 224.1.1.1 is the interface between P1 and PE1. As such, P1 forwards the multicast packet to PE1.

After receiving the multicast packet from P1, PE1 analyses the header of the multicast packet to learn that it is addressed to 224.1.1.1. Since PE1 stores information relating to the mapping between 224.1.1.1 and 239.1.1.1 and information relating to the local receiver of 239.1.1.1, PE1 determines that the multicast packet is for CE10. As such, PE1 forwards the multicast packet to CE10.

(ii) The second outgoing interface for 224.1.1.1 at PE2 is the interface between PE2 and PE3, in which case the multicast packet is forwarded to PE3.

Based on the header of the multicast packet, PE3 determines that the multicast packet is for public network multicast group address 224.1.1.1. In its forwarding table, the outgoing interface for 224.1.1.1 is the interface between PE3 and PE4. As such, PE4 forwards the multicast packet to PE4.

Upon receiving the multicast packet from PE3, PE4 analyses the header of the multicast packet to learn that it is addressed to 224.1.1.1. Since PE4 stores information relating to the mapping between 224.1.1.1 and 239.1.1.1 and information relating to the local receiver of 239.1.1.1, PE4 determines that the multicast packet is for CE40. As such, PE4 forwards the multicast packet to CE40.

In one example, multicast packets are forwarded in the VPLS network in a broadcast manner followed by a multicast manner. Prior to storing the forwarding information and encapsulating the multicast packet with the address of the public network multicast group, the multicast source PE device encapsulates the multicast packet with an VPLS label and broadcast it within the VSI1 domain. At this stage, multicast traffic is broadcasted within the VPLS network.

After the forwarding information for the public network multicast group is available and multicast packets are encapsulated with its address, multicast packets are forwarded over the public network in a multicast manner. Since a multicast source PE device triggers and transmits an MD packet after receiving a multicast packet, each peer PE device stores forwarding information for the public network multicast address fairly shortly after receiving the MD packet. Compared to broadcasting or unicasting of multicast packets, forwarding the multicast packets in a multicast manner reduces wastage of network bandwidth, and improves network utilisation.

After encapsulating the multicast packets with a public network multicast tunnel header having the address of the public network multicast group, if any other CE device connected to a PE device joins the private network multicast group, the PE device may transmit a PIM join packet and updates local information that the CE device is now a receiver of the private network multicast group.

For example, consider the situation where PE3 receives an IGMP request packet transmitted by CE30 to join private network multicast group 239.1.1.1. Since PE3 has previously received an MD packet sent by PE2 and stores the mapping information between the private network multicast group address 239.1.1.1 and public network multicast address 224.1.1.1, PE3 adds CE30 as a receiver for the private network multicast address, and broadcasts the IGMP request packet to join 239.1.1.1 and PIM join packet to join 224.1.1.1 within the network. As such, multicast traffic is directed to PE3. To retain synchronisation of private network multicast information, IGMP and PIM packet flooding is performed within the VPLS network.

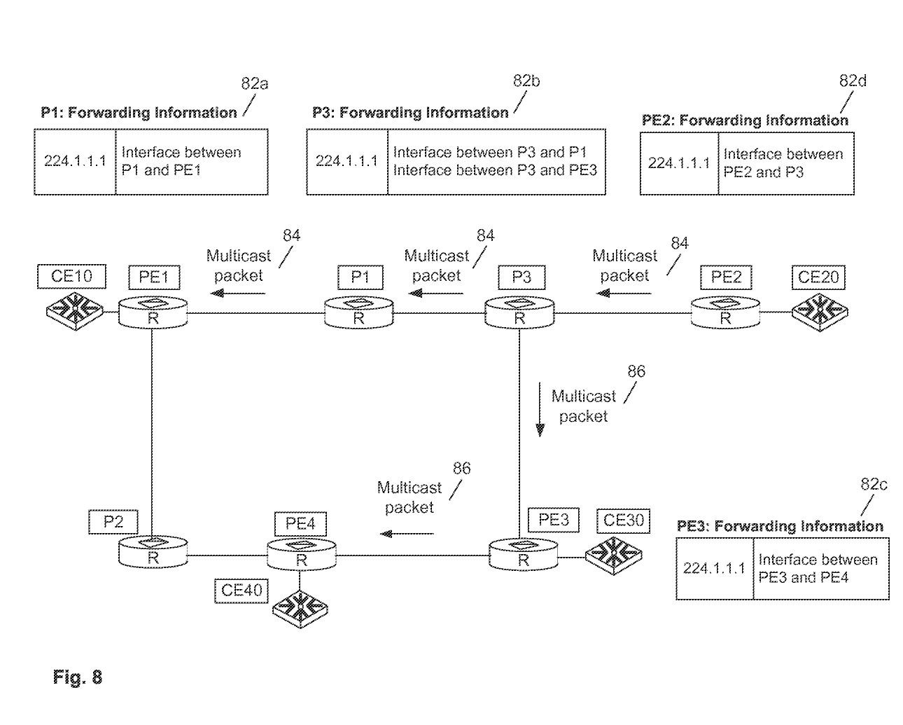

In another example, FIG. 8 shows a variation of the VPLS network topology in FIG. 6. In this case, PE4 is connected to multicast source PE2 via PE3 and P3 instead of via PE3 only. Similarly, PE1 and PE4 join the private network multicast group 239.1.1.1 and the public network multicast group 224.1.1.1 according to the blocks in FIG. 2 and FIG. 5.

After the blocks in FIG. 7, the forwarding information stored at devices upstream of the multicast source PE2 and at PE2 are as follows:
82a at P1: 224.1.1.1→Interface between P1 and PE1;
82b at P3: 224.1.1.1→Interface between P3 and P1, and 224.1.1.1→Interface between P3 and PE3;
82c at PE3: 224.1.1.1→Interface between PE3 and PE4.
82d at PE2: 224.1.1.1→Interface between PE2 and P3.

Although multicast packets have to be transmitted to PE1 and PE3, the forwarding table at PE2 only has one outgoing interface, i.e. the interface between PE2 and P3, over which the multicast packets are delivered. When PE2 encapsulates a multicast packet received from CE20 with address 224.1.1.1, PE2 will forward the multicast packet 84 to the interface between PE2 and P3. As such, based on the forwarding information, replication of multicast packets is not performed if they are transmitted on a shared link in the public network connecting the multicast source with the receiving PE devices. This improves bandwidth utilisation and reduces wasteful over-provisioning to deliver unnecessary replicated traffic.

The multicast packet 84 then arrives at P3, which learns from the header and its forwarding table that the packet should be forwarded to two outgoing interfaces. Specifically, the multicast packet 84 is forwarded to P1 via the interface between P3 and P1, and another copy 86 of the multicast packet is forwarded to PE3 via the interface between P3 and PE3. PE3 and P1 then forward the multicast packets 84 and 86 to PE1 and PE4 respectively.

Leaving the Private and Public Network Multicast Groups

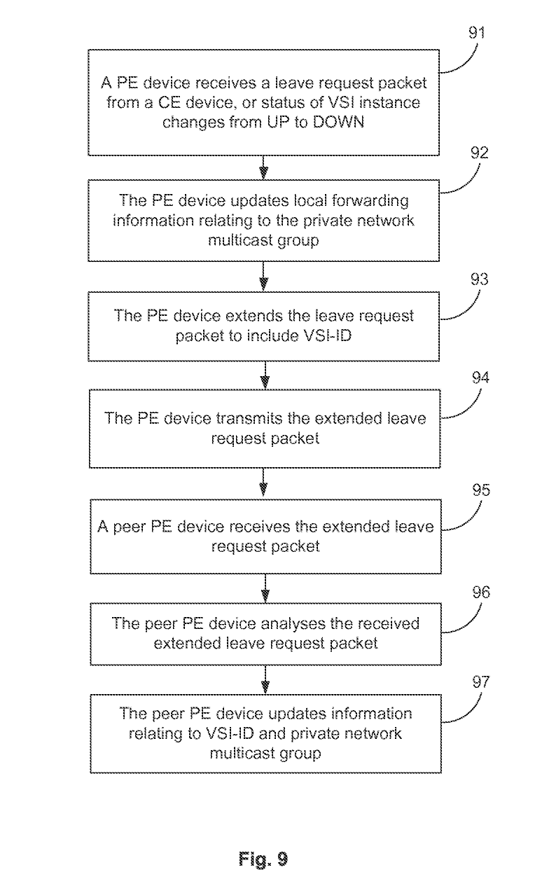

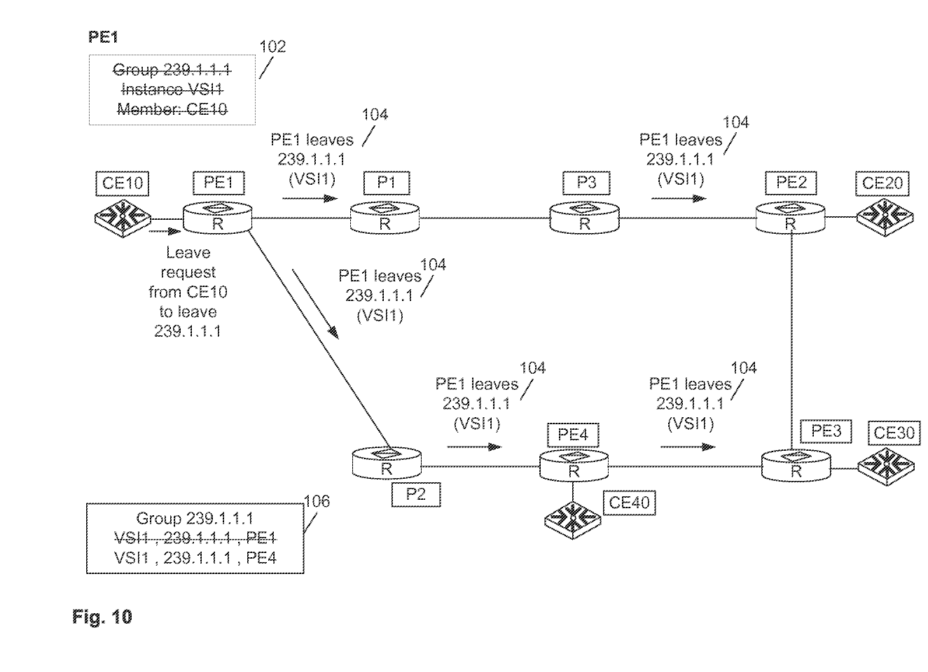

An example method of leaving a private network multicast group in the VPLS network will be explained with reference to FIG. 9 and FIG. 10. Any suitable communications protocol for managing group membership may be used, such as the Internet Group Management Protocol (IGMP) exemplified below.

At block 91, a PE device receives a leave request packet from a CE device to leave a private network multicast group. For example, the leave request packet may be in the form of an IGMP notification packet. In general, ACs connecting the PE and CE devices are IGMP-enabled to facilitate sending and receiving of IGMP packets. The example process described at blocks 92 to 97 below is also performed when the status of the VSI changes from UP to DOWN.

At block 92, the PE device updates its local forwarding information for the private network multicast group. More specifically, the PE device uses its local forwarding information to determine whether there is more than one outgoing interface for the private network multicast group. If yes, the PE device deletes the CE device that transmitted the leave request packet as an outgoing interface. Otherwise, if the CE device is the only outgoing interface for the private network multicast group, the private network multicast group is deleted from its local forwarding information.

In the example in FIG. 10, CE10 wishes to leave the private network multicast group 239.1.1.1 and sends an IGMP notification packet to PE1. After receiving the IGMP notification packet, PE1 determines whether there is any other CE device that is an outgoing interface for the private network multicast group. In this case, CE10 is the only outgoing interface, and PE1 deletes its local forwarding information of private network multicast group 239.1.1.1; see 102 in FIG. 10.

At block 93, the PE device extends the leave request packet to include the VSI-ID of the VSI. An example structure of an extended IGMP notification packet is similar to the structure shown in FIG. 4(a). In this case,
‘Type’ identifies the IGMP packet type, such as 0x11 for a query packet; 0x16 for a report packet; and 0x27 for an extended leave request packet;
‘Max Response Time’ identifies a maximum time to wait before responding to a query packet;
‘VSI-ID’ is the ID of the VSI, identifying the instance number to which the IGMP request packet belongs;
‘Checksum’ is a check sum for the IGMP packet; and
‘Multicast Address’ is an address of the private network multicast group, such as 239.1.1.1 used in this example.

At block 94, the PE device transmits the extended leave request packet to peer PE devices within the VSI domain In the example in FIG. 10, the extended packet 94 is broadcasted to reach peer PE devices PE2, PE3 and PE4.

At blocks 95 and 96, after receiving and analysing the extended packet, each peer PE device proceeds to updates the membership information relating to VSI-ID, by deleting the VSI-ID, private network multicast group address and PW information associated with the PE device that transmitted the extended packet.

Referring to block 92 again, if the private network multicast group is removed from the PE device, the PE device also sends a PIM notification packet to upstream devices to notify its exit from the public network multicast group address associated with the private network multicast group. The upstream devices then update its forwarding information for the public network multicast group address to delete the outgoing interface associated with the PE device.

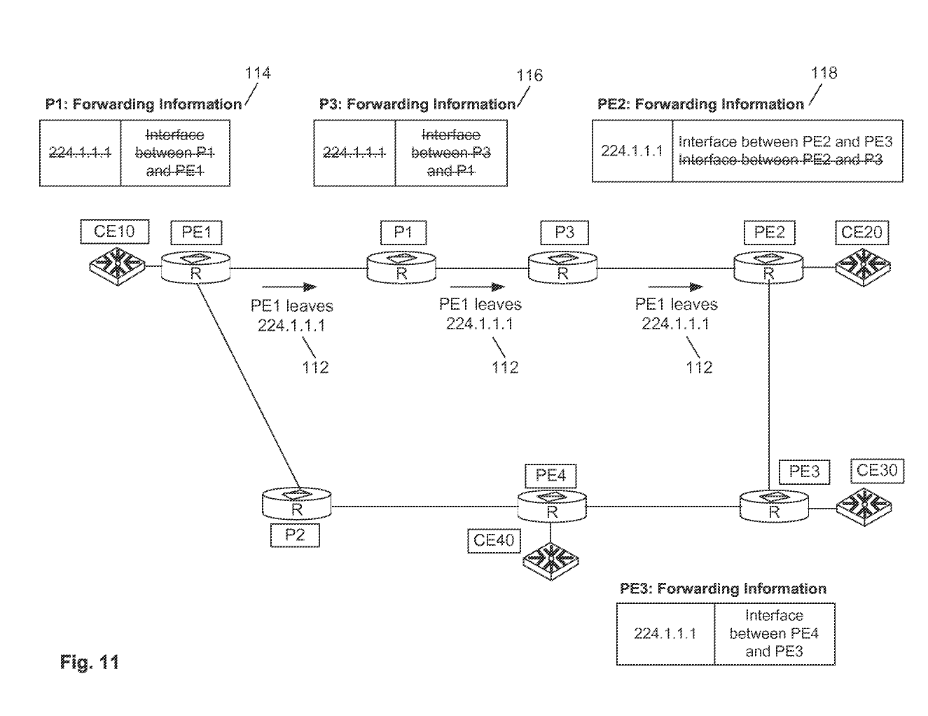

In the example in FIG. 11, a PIM notification packet 112 from PE1 reaches P1 and P3 before arriving at multicast source PE2. PE1 updates its forwarding information 114 to remove the interface between P1 and PE1 as an outgoing interface for 224.1.1.1 and P3 updates its forwarding information 116 to remove the interface between P3 and P1 as an outgoing interface for 224.1.1.1. Similarly, the multicast source PE2 also updates its forwarding information 118 to remove the interface between PE2 and P3 as an outgoing interface for 224.1.1.1. Multicast traffic from PE2 to 239.1.1.1 will no longer be forwarded to PE3.

Network Device

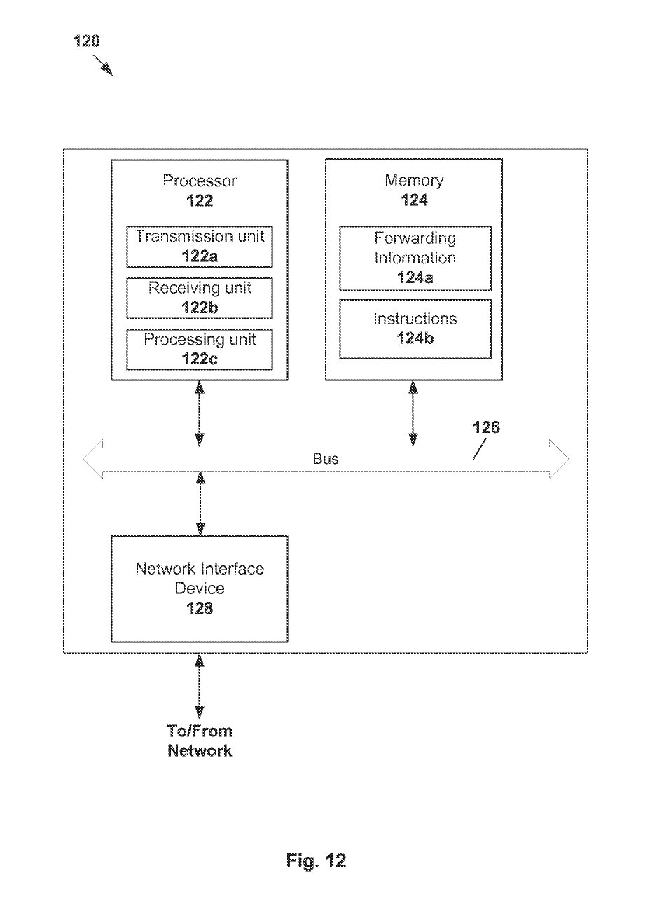

The above examples can be implemented by hardware, software or firmware or a combination thereof. Referring to FIG. 12, an example structure of a network device capable of acting as a PE device is shown. The example network device 120 includes a processor 122, a memory 124 and a network interface device 128 that communicate with each other via bus 126. The processor 122 implements functional units in the form of a transmission unit 122a, a receiving unit 122b, and a processing unit 122c. Information may be transmitted and received via the network interface device 128, which may include one or more logical or physical ports that connect the network device 120 to another network device.

In the case of the network device 120 acting as a first PE device:
The transmission unit 122a is to transmit, to a second provider edge device in the virtual switching instance, a packet having an address of a private network multicast group and an address of a public network multicast group associated with the private network multicast group.
The receiving unit 122b is to receive, from the second provider edge device, a join request packet to join the public network multicast group.
The processing unit 122c is to store forwarding information 124a for the public network multicast group in the memory 124b. The forwarding information 124a relates to an interface over which the join request packet is received by the first provider edge device.
The processing unit 122c is further to encapsulate a multicast packet for the private network multicast group with the address of the public network multicast group.
The transmission unit 122a is further to transmit the encapsulated multicast packet according to the address of the public network multicast group and forwarding information.

In the case of the network device 120 acting as a second PE device:
The receiving unit 122b is to receive, from a first provider edge device in the virtual switching instance, a packet having an address of a private network multicast group and an address of a public network multicast group associated with the private network multicast group.
The processing unit 122c is to determine whether a customer edge device connected to the second provider edge device is a receiver of a private network multicast group.
The transmission unit 122a is to, if the determination is affirmative, transmit a join request packet to join the public network multicast group to receive a multicast packet from the first device, but otherwise, not transmit the join request packet.
In this example, the multicast packet is encapsulated with the address of the public network multicast group and transmitted by the first provider edge device according to the address of the public network multicast group and forwarding information 124a relating to an interface over which the join request packet is received by the first provider edge device.

A network device acting as P device or a CE device may have a structure similar to the example in FIG. 12. Similarly, the network device acting as a P device or CE device has a processor 122, memory 124 and a network interface device 128 communicating with each other via a bus 126.

For example, the various methods, processes and functional units described herein may be implemented by the processor 122. The term ‘processor’ is to be interpreted broadly to include a CPU, processing unit, ASIC, logic unit, or programmable gate array etc. The processes, methods and functional units may all be performed by a single processor 120 or split between several processors (not shown in FIG. 12 for simplicity); reference in this disclosure or the claims to a ‘processor’ should thus be interpreted to mean ‘one or more processors’. Although one network interface device 128 is shown in FIG. 12, processes performed by the network interface device 128 may be split between several network interface devices. As such, reference in this disclosure to a ‘network interface device’ should be interpreted to mean ‘one or more network interface devices”.

The processes, methods and functional units may be implemented as machine-readable instructions executable by one or more processors, hardware logic circuitry of the one or more processors or a combination thereof. In the example in FIG. 12, the machine-readable instructions 124b are stored in the memory 124.

Further, the processes, methods and functional units described in this disclosure may be implemented in the form of a computer software product. The computer software product is stored in a storage medium and comprises a plurality of instructions for making a computer device (which can be a personal computer, a server or a network device such as a router, switch, bridge, host, access point etc.) implement the methods recited in the examples of the present disclosure.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

It will be appreciated that numerous variations and/or modifications may be made to the processes, methods and functional units as shown in the examples without departing from the scope of the disclosure as broadly described. The examples are, therefore, to be considered in all respects as illustrative and not restrictive.

1. A method for multicast packet transmission by a first provider edge device in a virtual switching instance, the method comprising:
the first provider edge device transmitting, to a second provider edge device in the virtual switching instance, a packet having an address of a private network multicast group and an address of a public network multicast group associated with the private network multicast group;
the first provider edge device receiving, from the second provider edge device, a join request packet to join the public network multicast group;
the first provider edge device storing forwarding information for the public network multicast group, wherein the forwarding information relates to an interface over which the join request packet is received by the first provider edge device;
the first provider edge device encapsulating a multicast packet for the private network multicast group with the address of the public network multicast group; and
the first provider edge device transmitting the encapsulated multicast packet according to the address of the public network multicast group and forwarding information.

2. The method of claim 1, wherein the first and second provider edge devices are connected via an intermediate device, and the encapsulated multicast packet is forwarded, by the intermediate device from the first device to the second provider edge device, based on forwarding information relating to an interface over which the join request packet is received by the intermediate device.

3. The method of claim 1, further comprising prior to the second provider edge device joining the private network multicast group,
receiving an extended request packet transmitted by the second provider edge device to join the private network multicast group, wherein the extended request packet includes an identifier of the virtual switching instance; and
storing membership information relating to the identifier of the virtual switching instance, the address of the private network multicast group and an address of the second provider edge device.

4. The method of claim 3, further comprising, prior to encapsulating and transmitting the multicast packet:
determining, from the membership information, whether the private network multicast group associated with the identifier of the virtual switching instance has at least one member;
if the determination is affirmative, encapsulating and transmitting the multicast packet, but otherwise, not encapsulating and transmitting the multicast packet.

5. The method of claim 1, further comprising:
receiving an extended leave request packet to leave the private network multicast group, wherein the extended request packet is transmitted by the second provider edge device and includes an identifier of the virtual switching instance; and
updating membership information relating to the identifier of the virtual switching instance, the address of the private network multicast group and an address of the second provider edge device.

6. The method of claim 1, wherein transmitting the packet having the address of a private network multicast group and the address of a public network multicast group is triggered by a first multicast packet received from a customer edge device connected to the first provider edge device.

7. A method for multicast packet transmission by a second provider edge device in a virtual switching instance, the method comprising:
the second provider edge device receiving, from a first provider edge device in the virtual switching instance, a packet having an address of a private network multicast group and an address of a public network multicast group associated with the private network multicast group;
the second provider edge device determining whether a customer edge device connected to the second provider edge device is a receiver of a private network multicast group; and
if the determination is affirmative, the second provider edge device transmitting a join request packet to the first device to join the public network multicast group to receive a multicast packet from the first device, but otherwise, not transmitting the join request packet;
wherein the multicast packet is encapsulated with the address of the public network multicast group and transmitted by the first provider edge device according to the address of the public network multicast group and forwarding information relating to an interface over which the join request packet is received by the first provider edge device.

8. The method of claim 7, wherein the first and second provider edge devices are connected via an intermediate device; and the multicast packet is forwarded, by the intermediate device from the first device to the second provider edge device, based on forwarding information relating to an interface over which the join request packet is received by the intermediate device.

9. The method of claim 7, further comprising storing mapping information relating to the address of a private network multicast group and the address of a public network multicast group.

10. The method of claim 9, further comprising:
receiving a multicast packet transmitted by the first provider edge device, the multicast packet being encapsulated with the address of the public network multicast group;
determining, from the mapping information, the address of the private network multicast group associated with the public network multicast group; and
transmitting the multicast packet to the customer edge device that is a receiver of the private network multicast group.

11. The method of claim 9, further comprising:
receiving a request packet from the customer edge device to leave the private network multicast group, wherein the customer edge device is the only receiver of the private network multicast group; and
determining, from the mapping information, the address of the public network multicast group associated with the private network multicast group; and
transmitting a leave request packet to leave the public network multicast group, wherein the first provider edge device receiving the leave request packet updates forwarding information for the public network multicast group.

12. The method of claim 7, further comprising, prior to the second provider edge device joining the private network multicast group:
receiving a request packet from the customer edge device to join the private network multicast group;
extending the request packet to include an identifier of the virtual switching instance; and
transmitting the extended request packet, wherein the first provider edge device receiving the extended request packet stores information relating to the identifier of the virtual switching instance, the address of the private network multicast group and the second provider edge device.

13. The method of claim 8, further comprising when (i) a request packet from the customer edge device to leave the private network multicast group, wherein the customer edge device is the only receiver of the private network multicast group at the second provider edge device, or (ii) a status of the virtual switching instance changing from UP to DOWN:
extending the leave request packet to include an identifier of the virtual switching instance; and
transmitting the extended leave request packet, wherein the first provider edge device receiving the extended leave request packet removes information relating to the identifier of the virtual switching instance, the address of the private network multicast group and the second provider edge device.

14. A network device for multicast packet transmission, the network device being capable of acting as a first provider edge device and comprising a transmission unit, a receiving unit and a processing unit, wherein:
the transmission unit is to transmit, to a second provider edge device in the virtual switching instance, a packet having an address of a private network multicast group and an address of a public network multicast group associated with the private network multicast group;
the receiving unit is to receive, from the second provider edge device, a join request packet to join the public network multicast group;
the processing unit is to store forwarding information for the public network multicast group, wherein the forwarding information relates to an interface over which the join request packet is received by the first provider edge device and is stored in a memory;
the processing unit is further to encapsulate a multicast packet for the private network multicast group with the address of the public network multicast group; and
the transmission unit is further to transmit the encapsulated multicast packet according to the address of the public network multicast group and forwarding information.

15. A network device for multicast packet transmission, the network device being capable of acting as a second provider edge device and comprising a receiving unit, a processing unit and a transmission unit, wherein:
the receiving unit is to receive, from a first provider edge device in the virtual switching instance, a packet having an address of a private network multicast group and an address of a public network multicast group associated with the private network multicast group;
the processing unit is to determine whether a customer edge device connected to the second provider edge device is a receiver of a private network multicast group; and
the transmission unit is to, if the determination is affirmative, transmit a join request packet to join the public network multicast group to receive a multicast packet from the first device, but otherwise, not transmit the join request packet;
wherein the multicast packet is encapsulated with the address of the public network multicast group and transmitted by the first provider edge device according to the address of the public network multicast group and forwarding information relating to an interface over which the join request packet is received by the first provider edge device.
